(19) United States
(12) Patent Application Publication
(10) Pub. No.: US 2013/0205401 A1
(43) Pub. Date: Aug. 8, 2013

(54) Apparatuses and methods for content protection using digital rights management (DRM) in webview or webkit

(71) Applicant: CONDEL INTERNATIONAL TECHNOLOGIES INC., George Town (KY)

(72) Inventors: Yeu-Chung LIN, Chang-hua (TW); Kwok-Chen TSENG, Longtan Township (TW)

(73) Assignee: CONDEL INTERNATIONAL TECHNOLOGIES INC., George Town (KY)

(21) Appl. No.: 13/834,849

(22) Filed: Mar. 15, 2013

(51) Int. Cl. G06F 21/10

(52) U.S. Cl. CPC G06F 21/10
USPC 726/26

(57) ABSTRACT

An electronic device for digital content protection using DRM is provided with a DRM agent, a plug-in, and a web browser. The DRM agent processes DRM-protected content associated with an electronic file or a web page. The plug-in enables access of the electronic file. The web browser comprises a WebView SDK installed with the DRM agent or a WebKit engine installed with the DRM agent. The WebView SDK activates the processing of the DRM-protected content of the DRM agent to obtain the web page portion-by-portion, and displays the web page with the obtained portions. The WebKit engine activates the processing of the DRM-protected content of the DRM agent to obtain the electronic file portion-by-portion, and uses the plug-in to execute the electronic file with the obtained portions, or displays the web page with the obtained portions.

### BACKGROUND OF THE INVENTION

1. Field of the Invention

The invention generally relates to the field of digital content protection, and more particularly, to apparatuses and methods for digital content protection using Digital Rights Management (DRM) by installing a DRM agent in the WebView Software Development Kit (SDK) and/or the WebKit engine of a web browser.

2. Description of the Related Art

Digital Rights Management (DRM) is an access control technology that is wildly used by hardware manufacturers, publishers, copyright holders, or individuals with the intent to limit the use of digital content. The original digital content to be protected is packaged and encrypted by a DRM server, and the DRM-protected content may be provided locally or accessible remotely via the Internet to users. For the case where the DRM-protected content is provided locally, an associated software application, such as Windows Media Player, QuickTime, or others, installed with a DRM agent is invoked for loading or executing the DRM-protected content. Specifically, the DRM agent first decrypts and un-packages the DRM-protected content to obtain the original digital contents, and then provides the original digital content to be executed by the associated software application according to one or more Rights Objects (ROs) which specify the permissions for the uses of the original digital content. For the case where the DRM-protected content is accessible remotely, a web browser is launched to obtain the DRM-protected content according to a certain communication protocol, such as the Hyper Text Transfer Protocol (HTTP). Next, similar to the first case described above, an associated software application installed with a DRM agent is responsible for loading or executing the DRM-protected content.

Note that, the conventional implementation of digital content protection using DRM is to install the DRM agent in the software applications. For example, the DRM agent may be installed in a VLC media player for playing the DRM protected multimedia files, or installed in a Sumatra Portable Document Format (PDF) viewer for viewing the DRM protected electronic files with the file extension of “pdf”. If several data formats are used for the original digital content, it is required to install a respective DRM agent in each of the associated software applications. However, the conventional implementation has a huge drawback as it requires the source code of the software applications for the DRM agent to be installed therein, or worse, it requires the source code of the Operating System (OS) and the configurations of the hardware resources for the DRM agent to be installed in the kernel of the OS. It is very likely that the company developing the software applications or OS will not be willing to authorize the source code to a third party. Also, the cost for authorization may be high, and the complexity for installing the DRM agent may be large.

### BRIEF SUMMARY OF THE INVENTION

With advances in networking technologies, the diversity of and the way of access to digital content have increased rapidly. For example, the HyperText Markup Language (HTML) supports displaying of texts, images, and java scripts, while the new HTML5 additionally supports playing of video and audio files with a native player of a web browser, and additionally supports playing other forms of multimedia, such as 3D gaming or Augmented Reality (AR), by means of using a plug-in associated with the specific form of multimedia; in this case, the plug-in could be a 3D Game Engine. Since more and more multimedia/data files are being accessible by web browsers, the invention proposes an efficient choice for users to use a single web browser as the means for accessing different forms of digital content, instead of using a plurality of software applications which are required to be pre-installed with DRM agents individually. Therefore, the invention aims to solve the aforementioned problems concerning the installation of DRM agents to the plurality of software applications, and proposes apparatuses and methods for digital content protection using DRM in the WebView Software Development Kit (SDK) and/or the WebKit engine of a web browser, such as the Firefox, Chrome, Opera, or Safari web browser, etc., for the Android system, the native web browser of the Android system (referred to herein as Android native web browser), or the Chromium web browser for any operating system, such as the Windows XP/7/8 system, Linux, or Mac OS X or iOS X system, etc. In addition, the apparatuses and methods for digital content protection using DRM may also be applied in the WebKit engine of a web browser for the operating systems other than the Android system, e.g., the Mac OS X or iOS system, Windows XP/7/8 system, or others, which provide the WebView SDK with different architecture or do not provide the WebView SDK at all.

In one aspect of the invention, an electronic device for protecting digital content, including web pages and electronic files, e.g., program files and multimedia/data files, using DRM is provided. The electronic device comprises a DRM agent, a plug-in, and a web browser. The DRM agent is configured to process DRM-protected content associated with an electronic file or a web page. The plug-in is configured to enable access of the electronic file. The web browser comprises a WebView SDK and/or a WebKit engine. The DRM agent may be installed on WebView SDK or WebKit engine or the combination of both. In a preferable embodiment, the WebView SDK activates the processing of the DRM-protected content of the DRM agent to obtain the web page portion-by-portion, and displays the web page with the obtained portions. The WebKit engine activates the processing of the DRM-protected content of the DRM agent to obtain the electronic file or the web page portion-by-portion, and uses the plug-in to execute the electronic file with the obtained portions, or displays the web page with the obtained portions.

In another aspect of the invention, a method for digital content protection using DRM in an electronic device is provided. The method comprises the steps of: launching a web browser comprising a WebView SDK installed with a DRM agent and/or a WebKit engine installed with the DRM agent, wherein the DRM agent is configured for processing DRM-protected content associated with an electronic file or a web page; activating, by the WebView SDK, the DRM agent to process the DRM-protected content for obtaining the web page portion-by-portion, and displaying, by the WebView SDK, the web page with the obtained portions, in response to the web browser comprising the WebView SDK installed with the DRM agent; and activating, by the WebKit engine, the DRM agent to process the DRM-protected content for obtaining the electronic file or the web page portion-by-portion, and using, by the WebKit engine, a plug-in to execute the electronic file with the obtained portions, or displaying, by the WebKit engine, the web page with the obtained portions, in response to the web browser comprising the WebKit engine installed with the DRM agent.

In yet another aspect of the invention, an electronic device for digital protecting electronic file content using DRM is provided. The electronic device comprises a plurality of DRM agents, a plug-in, and a web browser. The DRM agents support a plurality of DRM schemes for processing DRM-protected content associated with an electronic file or a web page using one of the DRM schemes. The plug-in is configured to enable access of the electronic file. The web browser comprises a WebView SDK installed with the DRM agents and/or a WebKit engine installed with the DRM agents. The WebView SDK activates the processing of the DRM-protected content of the DRM agents to obtain the web page portion-by-portion, and displays the web page with the obtained portions. The WebKit engine activates the processing of the DRM-protected content of the DRM agents to obtain the electronic file or the web page portion-by-portion, and uses the plug-in to access the electronic file with the obtained portions, or displays the web page with the obtained portions.

Other aspects and features of the invention will become apparent to those with ordinary skill in the art upon review of the following descriptions of specific embodiments of the electronic devices and methods for digital content protection using DRM.

### BRIEF DESCRIPTION OF DRAWINGS

The invention can be more fully understood by reading the subsequent detailed description and examples with references made to the accompanying drawings, wherein:

FIG. 1 is a block diagram illustrating the software architecture of an electronic device according to an embodiment of the invention;

FIG. 2 is a block diagram illustrating the hardware architecture of an electronic device according to an embodiment of the invention;

FIGS. 3A and 3B show a flow chart illustrating the shouldInterceptRequest method according to an embodiment of the invention;

FIG. 4 is a schematic diagram illustrating an exemplary relation between an entry file and a plurality of subsequently invoked files;

FIG. 5A is a schematic diagram illustrating the calling sequence of the classes in the WebKit engine involved during the loading of the DRM-protected content associated with an electronic file according to an embodiment of the invention; and

FIG. 5B is a schematic diagram illustrating the returning sequence of the classes in the WebKit engine involved during the loading of the DRM-protected content associated with an electronic file according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

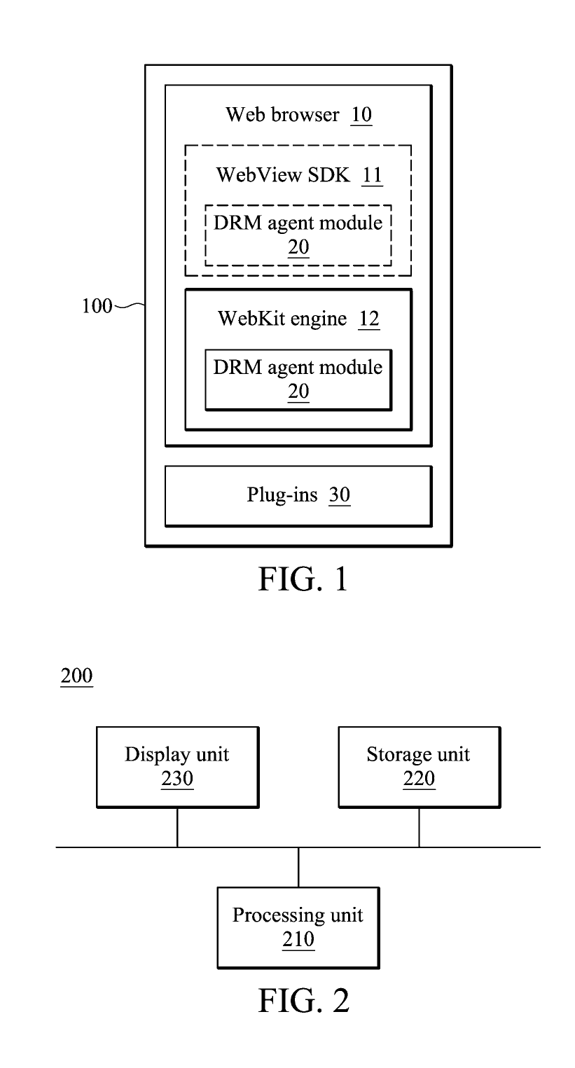

FIG. 1 is a block diagram illustrating the software architecture of an electronic device according to an embodiment of the invention. The software architecture 100 of the electronic device contains a web browser 10, a DRM agent module 20, and a plurality of plug-ins 30. The web browser 10 includes a WebKit engine 12 installed with the DRM agent module 20 (denoted with solid lines) and optionally a WebView Software Development Kit (SDK) 11 installed with the DRM agent module 20 (denoted with dotted lines), due to the fact that a web browser may be constructed by only a WebKit engine or both of a WebView SDK and a WebKit engine. The web browser 10 is a software application which provides the functionality of a web browser for retrieving, presenting, and traversing information resources either in a local storage device or on a local/remote web page. Specifically, an information resource may be identified by a Uniform Resource Identifier (URI) and may be a web page, an electronic file (e.g., a multimedia/data file or a program file), or other piece of content. Alternatively, the web browser 10 may also be used to access information provided by locally maintained electronic files. The web browser 10 may be a Firefox, Chrome, Chromium, Internet Explorer (IE), Opera, or Safari web browser, or a web browser constructed by a WebView SDK and/or a WebKit engine bearing similar functions of the aforementioned ones, etc.

The WebView SDK 11 is generally referred to as a view class that displays web pages, and this view class is the basis upon which a set of Application Programming Interfaces (APIs) is provided for users to roll the web browser 10 or simply display some online or local contents. In addition, the WebView SDK 11 uses the underlying WebKit engine 12 to display web pages, and also includes methods to navigate forward and backward through a history, zoom in and out, perform text searches, and more. Note that, the WebKit engine 12 is an open source browser engine, while the WebView SDK 11 may also be open sourced as well or provide only the set of APIs, depending on the web browser and the operating system in use. For example, in the Android native web browser or the Chromium web browser, both of the WebView SDK 11 and the WebKit engine 12 are open sourced.

The plug-ins 30 may also be referred to as browser extensions or add-ons, which generally refer to computer programs for extending the functionality of a web browser, e.g., the web browser 10. In this embodiment, the plug-ins 30 enable the access of certain electronic files, including program files and multimedia/data files, for the web browser 10. For example, the plug-ins 30 may comprise a Flash plug-in for providing the functionality similar to the Adobe Flash Player, and the electronic files corresponding to the Flash plug-in are the electronic files with the file extension of “swf”. The plug-ins 30 may comprise a SilverLight plug-in for providing the functionality similar to the SilverLight Player, and the electronic files corresponding to the SilverLight plug-in are the electronic files with the file extension of “xap”. The plug-ins 30 may comprise a Unity 3D plug-in for providing the functionality similar to the Unity 3D Game Engine, and the electronic files corresponding to the Unity 3D plug-in are the electronic files with the file extension of “unity3d” or “js”. The plug-ins 30 may comprise a Window Media Player (WMP) plug-in for providing the functionality similar to the WMP, and the electronic files corresponding to the WMP plug-in are the data files, such as video and/or audio files, with the file extension of “wmv” or “wma”. The plug-ins 30 may comprise a QuickTime plug-in for providing the functionality similar to the QuickTime player, and the electronic files corresponding to the QuickTime plug-in are the data files, such as video and/or audio files, with the file extension of “mov” or “qt”. The plug-ins 30 may comprise an Adobe Reader plug-in for providing the functionality similar to the Adobe Reader, and the electronic files corresponding to the Adobe Reader plug-in are the data files with the file extension of “pdf”.

Specifically, because the plug-ins 30 are installed in the web browser 10, the web browser 10 may detect the existence of the plug-ins 30, and when the web browser 10 is required to access the electronic files associated with one or more of the plug-ins 30, it may invoke the corresponding plug-in(s) of the plug-ins 30 associated with the specific file to be accessed, i.e., using the plug-ins 30, to access the electronic files. Note that, during the access of the electronic files, any input and output associated with the electronic files are made through the web browser 10. Taking a Flash file being accessed as an example, if the Flash file requires a user to input a command, the command will be received by the web browser 10 via an I/O device (not shown), such as a keyboard, a touch pad, or a touch panel, etc., and then forwarded to the plug-ins 30. Likewise, if the Flash file requires to invoke other Flash files or multimedia/data files, the requirement will be directed to be handled by the web browser 10.

The DRM agent module 20 is a trusted entity in compliance with the DRM protocol(s) of one or more specific DRM schemes, i.e., the DRM agent module 20 may support the use of a plurality of DRM schemes, wherein each DRM scheme is practically performed by a specific corresponding DRM agent. The DRM agent module 20 is responsible for processing DRM-protected content according to one or more Rights Objects (ROs) corresponding to the DRM-protected content, which define permissions for accessing the DRM-protected content in the electronic device, using the supported the DRM schemes. The processing of the DRM-protected content includes decrypting and un-packaging of the DRM-protected content, and enforcing permissions and constraints associated with the DRM-protected content, as well as controlling access to the DRM-protected content. Note that, the DRM agent module 20 is installed in the web browser 10, and the access to any DRM-protected content must be made through the web browser 10. Accordingly, system performance and processing efficiency may be improved, since the DRM-protected content may be displayed or executed directly in the web browser 10 without redirecting the DRM-protected content to be handled by external software applications, which is the routine for the conventional ways of implement DRM agent on application software, rather than on web browser. As well, due to the DRM agent module 20 incorporates a plurality of DRM agents, this embodiment can solve the interoperability problem among different DRM schemes.

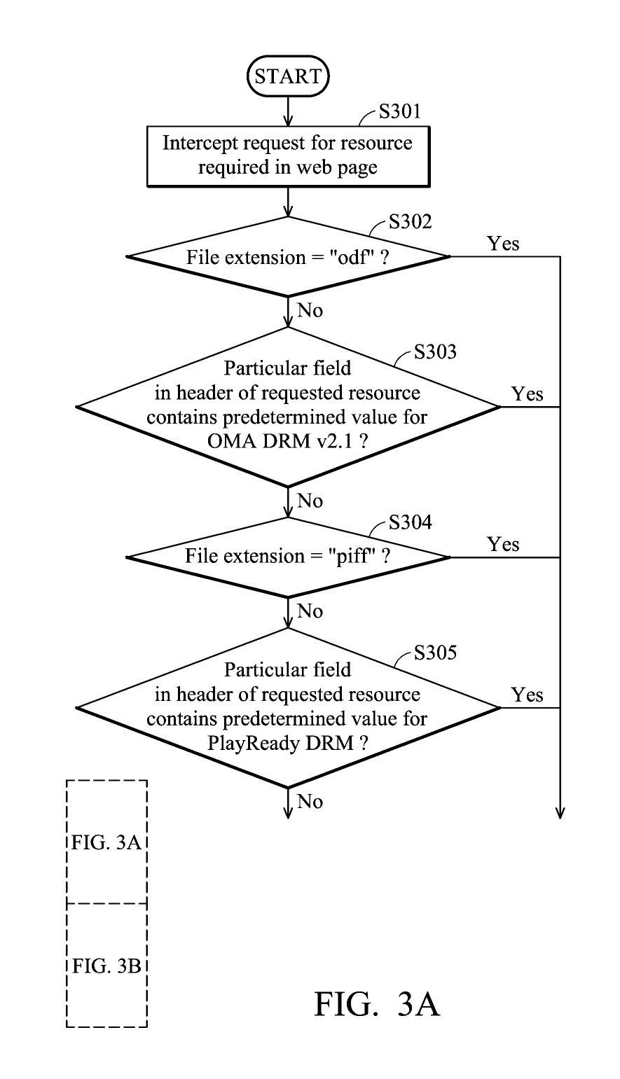

FIG. 2 is a block diagram illustrating the hardware architecture of an electronic device according to an embodiment of the invention. The hardware architecture 200 of the electronic device contains a processing unit 210, a storage unit 220, and a display unit 230. The processing unit 210 may be a general-purpose processor, an application processor, or a Micro-Control Unit (MCU) of the electronic device. The storage unit 220 may be a volatile memory, such as a Random Access Memory (RAM), a non-volatile memory, such as a flash memory, a hard disk, an optical disk, or any combination thereof, for storing the DRM-protected content and the program code or machine code of the web browser 10, the DRM agent module 20, and the plug-ins 30, which when loaded and executed by the processing unit 210, may perform the respective functions thereof. In addition, the storage unit 220 may also store the RO(s) corresponding to the DRM-protected content, wherein the DRM-protected content and the RO may be received from a DRM server (not shown) remotely located on the Internet, or may be read out from another storage medium (not shown) accessible when coupled to the electronic device. The display unit 230 may be a Cathode Ray Tube (CRT) screen, a Liquid Crystal Display (LCD), a plasma display panel, or others, for displaying a graphic user interface of the web browser 10, which the user may interact with. Although not shown, the hardware architecture 200 may comprise other functional units, such as a keyboard/keypad, a mouse, a touch pad, or a communication unit, such as an Ethernet card/chipset, a Wireless-Fidelity (WiFi) card/chipset, or a Baseband and Radio Frequency (RF) chipset for cellular communications.

Taking the Android native web browser or the Chromium web browser as preferred examples, the installation of the DRM agent module 20 is particularly feasible since the Android native web browser and the Chromium web browser are open-sourced web browsers and the source code thereof is available and free for all, but the invention is not limited thereto. Please note that, the Android native web browser and the Chromium web browser installed with the DRM agent module 20 is different from the genuine Android native web browser and the genuine Chromium web browser released to the public by Google™, and it may be referred to as a custom web browser made and used specifically in this invention.

In response to the web browser 10 comprising the WebView SDK 11 installed with the DRM agent module 20, the WebView SDK 11 activates the processing of the DRM-protected content of the DRM agent module 20 to obtain the web page portion-by-portion, and displays the web page with the obtained portions. Specifically, the DRM agent module 20 is installed to a shouldInterceptRequest method and a shouldOverrideUrlLoading method of a child class which is registered to a WebViewClient class of the APIs of the WebView SDK 11. The WebView SDK 11 may have several customization points where user defined behaviors may be added, and the WebViewClient class is one of them, which is called when things happen that impact the rendering of web contents (i.e., handled by the shouldInterceptRequest method thereof) or when interception of a Uniform Resource Locator (URL) loading is desired (i.e., handled by the shouldOverrideUrlLoading method thereof). A child class inherits the methods of the parent class which it has registered to. That is, the child class inherits the shouldInterceptRequest method and the shouldOverrideUrlLoading method of the WebViewClient class.

The shouldInterceptRequest method may be installed with the DRM agent module 20 (i.e., the shouldInterceptRequest method is overwritten and is different from a genuine shouldInterceptRequest method in the APIs of the WebView SDK for the Android system released to the public, and it may be referred to as a custom method made and used specifically in this invention), so as to intercept a request for a resource required in the web page, determine whether the resource is DRM protected using one of the DRM schemes supported by the DRM agent module 20 according to the file extension or header of the resource (i.e., select an appropriate DRM scheme supported by DRM agent module 20 to check if the resource is DRM protected), and if so, redirect the request to the DRM agent module 20 for obtaining the resource portion-by-portion using the appropriate DRM scheme.

A resource may be indicated by the HyperText Markup Language (HTML) or HTML5 src attribute of the web page. For example, an exemplary HTML/HTML5 code for requesting an image in a web page is given below:

<a><img src=‘file:///c:\MIB3_poster.png”/>click here</a>, wherein <a> and <img> are HTML/HTML5 elements (or referred to as nodes), “src” is an attribute, the part encompassed by <a> and <a> is a hyperlink represented by a URL for indicating the location and file name of the requested image. Note that, the requested resource may comprise a text, java script, Cascade Style Sheet (CSS), and canvas 2D, etc. The exemplary HTML/HTML5 code for requesting a text, java script, Flash file, CSS, or canvas 2D is similar to the case where an image is requested, as described above, and thus, is omitted herein for brevity.

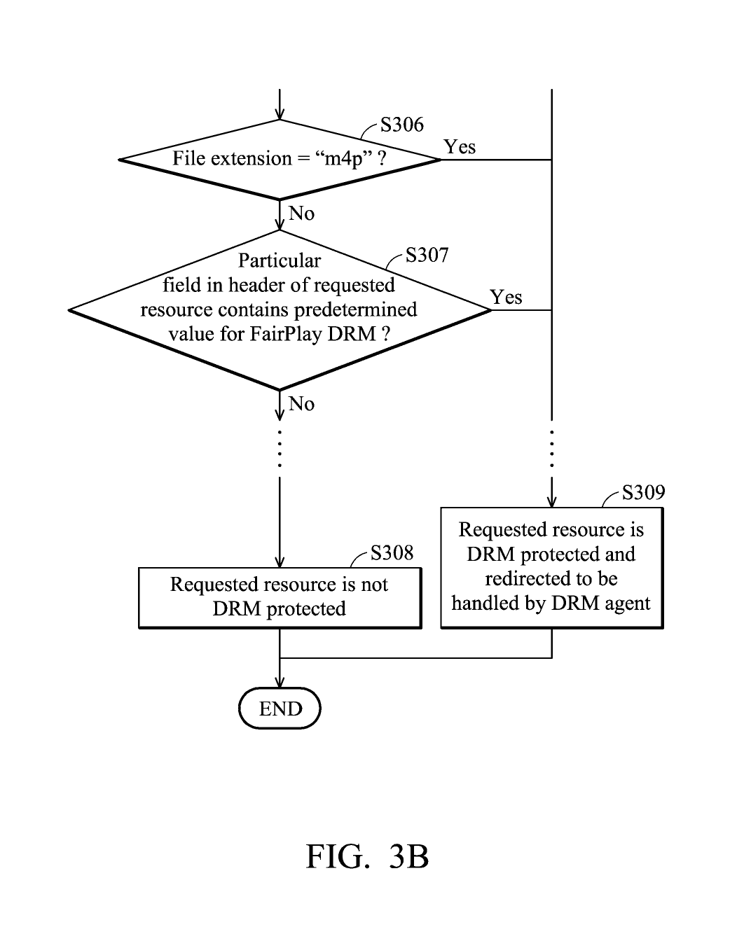

To further clarify, due to the fact that different DRM schemes, such as OMA DRM v2.1, PlayReady DRM, and FairPlay DRM, etc., may be employed, the step of determining whether the resource is DRM protected may be performed once for each DRM scheme supported by the DRM agent module 20. FIGS. 3A and 3B show a flow chart illustrating the shouldInterceptRequest method according to an embodiment of the invention. To begin, the shouldInterceptRequest method intercepts a request for a resource required in the web page (step S301). Next, it is first checked if the requested resource is DRM protected in compliance with the OMA DRM v2.1, by determining whether the file extension is “odf” (step S302) and determining whether a particular field in the header of the requested resource contains a predetermined value for the OMA DRM v2.1 (step S303). That is, the check is conducted by a specific API of the DRM agent corresponding to OMA DRM v2.1. If both of the determination results in the steps S302 and S303 are negative, it is subsequently checked if the requested resource is DRM protected in compliance with the PlayReady DRM, by determining whether the file extension is “piff” (step S304) and determining whether a particular field in the header of the requested resource contains a predetermined value for PlayReady DRM (step S305). If both of the determination results in the steps S304 and S305 are negative, it is subsequently checked if the requested resource is DRM protected in compliance with the FairPlay DRM, by determining whether the file extension is “m4p” (step S306), and determining whether a particular field in the header of the requested resource contains a predetermined value for FairPlay DRM (step S307). The check continues until either a DRM agent retrieve a correct value or all the DRM agents in the DRM agent module 20 are exhausted and cannot retrieve a correct value. If the determination results in the steps S302 to S307 and following steps (if any) are negative, it means that the requested resource is not DRM protected, or the requested resource is protected by a DRM scheme not supported by DRM agent module 20, so it returns to its parent class (step S308). Otherwise, if one of the determination results in the steps S302 to S307 and subsequent steps (if any) is positive, it means that the requested resource is DRM protected and the shouldInterceptRequest method redirects the request to the DRM agent module 20 for obtaining the resource portion-by-portion using the appropriate DRM scheme (step S309). In other words, the DRM agent module 20 is activated to process the DRM-protected content associated with the web page.

Note that, the steps S303, S305, and S307 are performed by activating the DRM agent module 20 to use its API(s) with the corresponding DRM schemes for reading the particular field in the header of the requested resource.

After processing the DRM-protected content, the DRM agent module 20 may obtain the Multipurpose Internet Mail Extensions (MIME) type, the encoding format (e.g., UTF-8), and the original data content of the requested resource, those of which provide access to the original data content for the web browser 100 to display. Note that, if the original data content is a DRM protected electronic file which is not supported by the genuine web browser or native player to access, the plug-ins 30 may be used for access of the original data content in the web browser 10. Particularly, the original data content may be stored arbitrarily in the memory to prevent copy attempts, and may only be accessed by the WebView SDK 11 using a link or pointer provided by the DRM agent module 20.

Alternatively, for the checking of whether the requested resource is DRM protected in compliance with the OMA DRM v2.1, only one of the steps S302 and S303 may be performed instead of performing both the steps S302 and S303. Likewise, for the checking of whether the requested resource is DRM protected in compliance with the PlayReady DRM and FairPlay DRM, only one of the steps S304 and S305 may be performed instead of performing both the steps S304 and S305, and only one of the steps S306 and S307 may be performed instead of performing both the steps S306 and S307.

In a first embodiment, the installation of the DRM agent module 20 in the WebView SDK 11 may be performed by inserting the source code of the DRM agent(s) in the DRM agent module 20 in the shouldInterceptRequest method. In a second embodiment, the installation of the DRM agent module 20 in the WebView SDK 11 may be performed by providing a code routine which was written using the API of the DRM agent(s) in the DRM agent module 20 for calling the libraries of the DRM agent(s) in the DRM agent module 20, dynamically or statically, and inserting the code routine in the shouldInterceptRequest method. An exemplary code for carrying out the second embodiment in the Android native web browser or the Chromium web browser is given below:

```
public WebResourceResponse shouldInterceptRequest
(WebView view, String url)
{
  boolean ret = getEncodedDataFromDRMLibrary(url);
  if (ret == true)
  {
    return new WebResourceResponse
    (m_MimeType, “UTF-8”, m_Data);
  }
  return super.shouldInterceptRequest(view, url);
}
private boolean getEncodedDataFromDRMLibrary(String url)
{
  boolean isInitOK = m_DRM.InitialDll( );
  if (isInitOK == true)
  {
    long handle = m_DRM.OpenDRMFile(url);
    long fileSize = m_DRM.GetDRMFileSize(handle);
    byte[ ] data = null;
    if (fileSize > 0)
    {
      data = m_ DRM.ReadDRMFile(1, (int) fileSize, handle);
      m_Data = new ByteArrayInputStream(data);
    }
    m_MimeType = m_DRM.GetContentMimeType(url);
    if (m_MimeType == null)
    {
      MimeTypeMap mimeTypeMap = MimeTypeMap.getSingleton( );
      String extension = MimeTypeMap.getFileExtensionFromUrl(url);
      m_MimeType =
      mimeTypeMap.getMimeTypeFromExtension(extension);
    }
    m_DRM.CloseDRMFile(handle);
    m_DRM.CloseDll( );
    if (m_Data != null && m_MimeType != null)
    {
      return true;
    }
  }
  return false;
}
```

In addition, the shouldOverrideUrlLoading method may be installed with the DRM agent module 20, so as to take over the control for loading of URLs, particularly when the URLs represent the electronic files that do not have corresponding plug-ins for the web browser 10 and require external software applications for execution, such as the VideoLAN Client (VLC) player. Specifically, the external software applications refer to the software applications pre-installed with the DRM agent module 20, i.e., the external software applications are capable of processing DRM-protected content. Note that, the access to any DRM-protected content, including the DRM-protected content not having corresponding plug-ins for access in the web browser 10, must be made through the web browser 10. An exemplary code for the installation of DRM agent module 20 to the shouldOverrideUrlLoading method in the Android native web browser or the Chromium web browser is given below:

```
public boolean shouldOverrideUrlLoading(WebView view, String url)
{
  String fileExtension = findFileExtension(url);
  if (fileExtension.equalsIgnoreCase(“txt”))
  {
    CallerManager caller = new CallerManager(m_Context);
    caller.executeApp(url);
    return true;
  }
  return super.shouldOverrideUrlLoading(view, url);
}
```

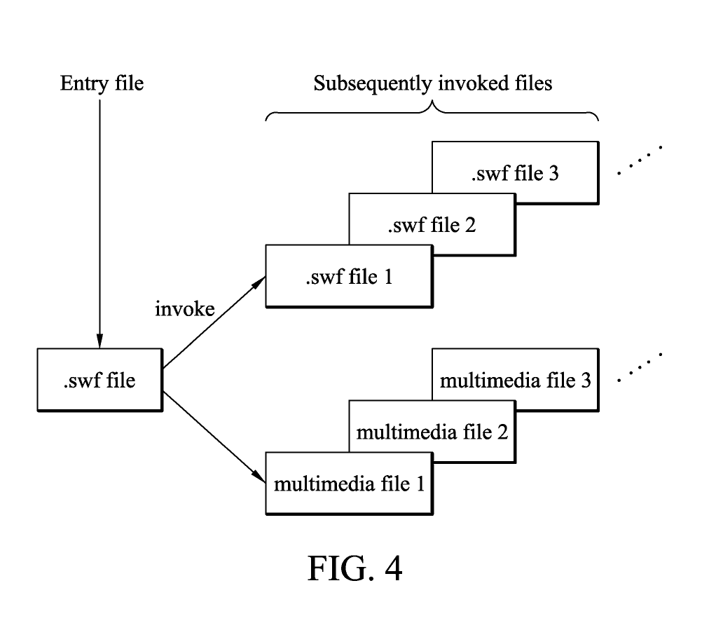

It is to be understood that, the WebView SDK 11 installed with the DRM agent module 20 may handle the resources which are DRM protected in a web page, including the resources with file extension of “html”, “js”, “css”, “png”, and the resources of an entry file that requires the plug-ins 30 for access, but not the subsequent electronic files which are DRM protected and invoked by the entry file, as shown in FIG. 4. For this case, the WebKit engine 12 activates the processing of the DRM-protected content of the DRM agent module 20 to obtain the electronic file portion-by-portion, and uses the plug-ins 30 to execute the electronic file with the obtained portions. Specifically, the DRM agent module 20 is installed to one or more of a plurality of methods in the WebKit engine 12, which are invoked during loading of the electronic file with a corresponding URL, so that the processing of the DRM-protected content by the DRM agent module 20 is activated when the web browser 10 is required to access the DRM-protected content associated with the electronic file. Later, when finishing the loading of the DRM-protected content associated with the electronic file, the WebKit engine 12 may use the plug-ins 30 to access the electronic file. Similar to the steps S302 to S307 in FIGS. 3A and 3B, the DRM-protected content associated with the electronic file may be checked first to see if it is DRM protected and by which DRM scheme it is protected with or without activating the DRM agent module 20, and if so, then the DRM agent appropriate for the DRM scheme in the DRM agent module 20 is activated for processing the DRM-protected content associated with the electronic file.

Alternatively, in addition to the access of electronic files, the WebKit engine 12 installed with the DRM agent module 20 may handle the displaying of web pages and other types of electronic files as well, since the WebView SDK 11 is generally built from the WebKit engine 12. This is particularly suitable for the case where the web browser 10 is for operating systems other than the Android system and provides the WebView SDK 11 with different architecture or does not provide the WebView SDK 11 at all.

Similar to the installation of the DRM agent module 20 in the WebView SDK 11 as described above, the installation of the DRM agent module 20 in the WebKit engine 12 may be performed by inserting the source code of the DRM agent module 20 in the set of methods in the WebKit engine 12, or by providing a code routine which was written using the API of the DRM agent module 20 for calling the libraries of the DRM agent module 20 dynamically or statically and inserting the code routine in the set of methods in the WebKit engine 12.

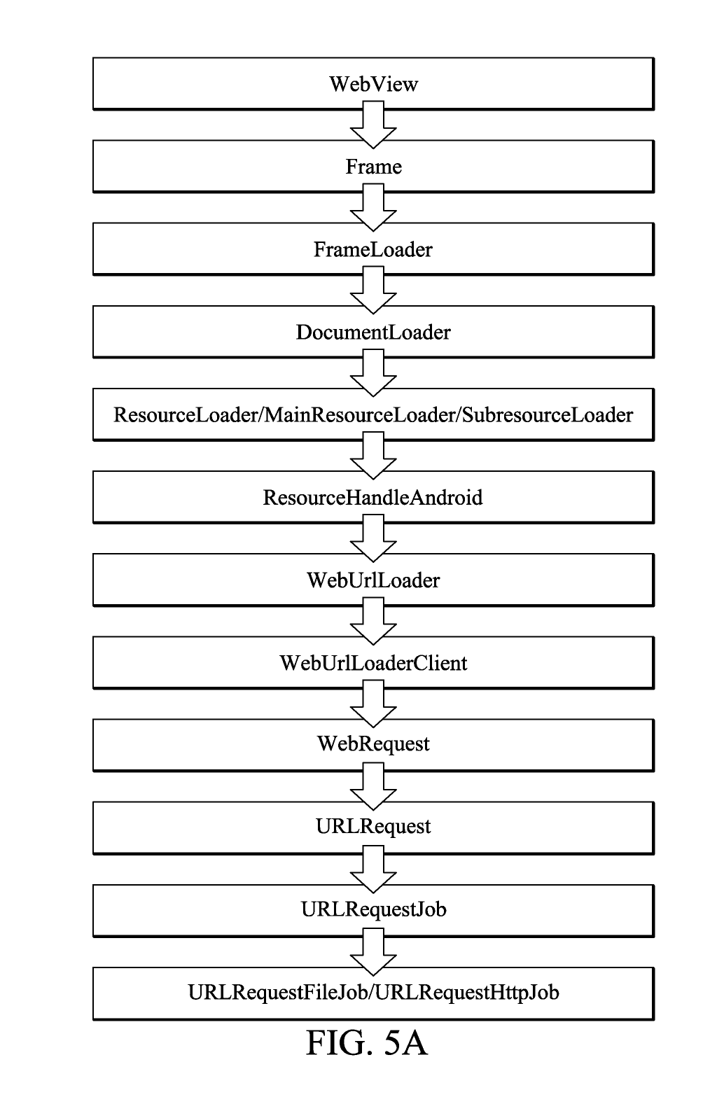

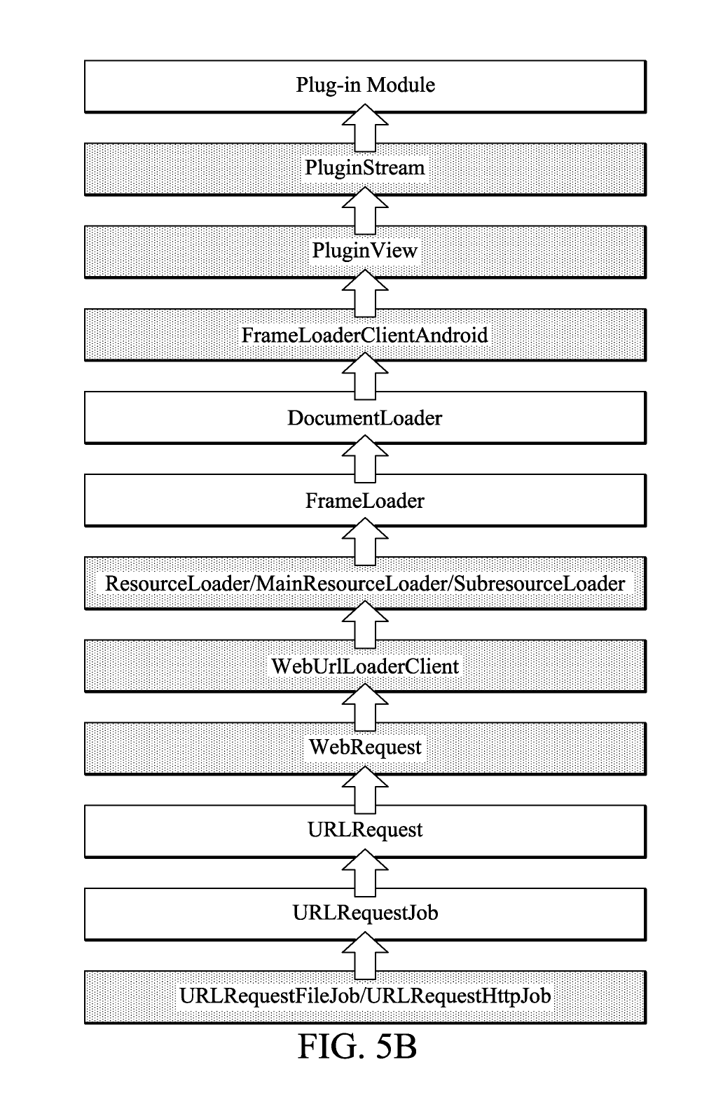

Taking the Android native web browser or the Chromium web browser as an example, the calling sequence of the classes involved during the loading of the DRM-protected content associated with the electronic files is illustrated in FIG. 5A, and the returning sequence of the classes involved during the loading of the DRM-protected content associated with the electronic files is illustrated in FIG. 5B. Particularly, as shown in FIG. 5B, the blocks with dotted background represent the classes where the set of methods installed with the DRM agent module 20 are selected from.

In a first embodiment, the installation of the DRM agent module 20 in the WebKit engine 12 may be implemented in the Start method, GetMimeType method, ReadRawData method, and Kill method of the URLRequestFileJob class (or URLRequestHttpJob or others of similar classes), depending on the scheme type (e.g., “file://” or “http://”) of the URL of the requested DRM-protected content associated with the electronic file. The Start method further comprises a Resolve method and a DidResolve method. The Resolve method is overwritten to determine whether the DRM-protected content indicated with the URL received by the WebKit engine 12 exists, and if so, obtain attributes, such as the data size, and time (e.g., time for establishment, modification, or last access of the electronic file), etc., of the electronic file by activating the DRM agent module 20. The DidResolve method is overwritten to move the file-reading pointer to the location of the electronic file by activating the DRM agent module 20, and determine the length of reading according to the data size provided by the Resolve method. The GetMimeType method is overwritten to inquire the MIME type of the electronic file by activating the DRM agent module 20. The ReadRawData method is overwritten to read out the data content of the electronic file according to the file-reading pointer and length provided by the DidResolve method. For example, if the electronic file is a continuous media, such as a video file, the resource loader may require the data content by segments for several times. If the electronic file is an image file, the resource loader may require the entire data content only once. The MIME type, data size, content, and location of the electronic file are passed down to the next class in the returning sequence. The Kill method is overwritten to terminate the loading of the DRM-protected content associated with the electronic file by activating the DRM agent module 20, when the electronic file has been successfully loaded, or when an error has occurred or a suspension is requested during the loading of the DRM-protected content associated with the electronic file.

In a second embodiment, the installation of the DRM agent module 20 in the WebKit engine 12 may be implemented in the OnResponseStarted method and OnReadCompleted method of the WebRequest class. The OnResponseStarted method is overwritten to create a WebResponse object. Also, the OnResponseStarted method is overwritten to activate the DRM agent module 20 for obtaining the MIME type and data size of the electronic file, and replace the MIME type and data size contained in a WebResponse object with the obtained MIME type and data size of the electronic file. The OnReadCompleted method is overwritten to activate the DRM agent module 20 for decrypting and un-packaging the DRM-protected content to obtain the electronic file, and determine the length and location of the electronic file in the memory. In addition, if the length of the electronic file is zero, the overwritten OnReadCompleted method may end the loading of the DRM-protected content in this class, and activate the DRM agent module 20 for closing the access to the electronic file. The WebResponse object, and the content and location of the electronic file are passed down to the next class in the returning sequence.

In a third embodiment, the installation of the DRM agent module 20 in the WebKit engine 12 may be implemented in the didReceiveResponse method, didReceiveData method, and didFinishLoading method of the WebUrlLoaderClient class. The didReceiveResponse method is overwritten to receive a WebResponse object from the last class in the returning sequence. Also, the didReceiveResponse method is overwritten to activate the DRM agent module 20 for obtaining the MIME type and data size of the electronic file, and replace the MIME type and data size contained in the WebResponse object with the obtained MIME type and data size of the electronic file. The didReceiveData method is overwritten to activate the DRM agent module 20 for decrypting and un-packaging the DRM-protected content to obtain the electronic file, and determine the length and location of the electronic file in the memory. The WebResponse object, and the content and location of the electronic file are passed down to the next class in the returning sequence. The didFinishLoading method is overwritten to activate the DRM agent module 20 for closing the access to the electronic file, when finishing the loading of the DRM-protected content in this class.

In a fourth embodiment, the installation of the DRM agent module 20 in the WebKit engine 12 may be implemented in the didReceiveResponse method, didReceiveData method, and didFinishLoading method of the ResourceLoader class (or MainResourceLoader or SubresourceLoader of similar classes). The didReceiveResponse method is overwritten to receive a ResourceResponse object from the last class in the returning sequence. Also, the didReceiveResponse method is overwritten to activate the DRM agent module 20 for obtaining the MIME type and data size of the electronic file, and replace the MIME type and data size contained in the ResourceResponse object with the obtained MIME type and data size of the electronic file. The didReceiveData method is overwritten to activate the DRM agent module 20 for decrypting and un-packaging the DRM-protected content to obtain the electronic file, and determine the length and location of the electronic file in the memory. The ResourceResponse object, and the content and location of the electronic file are passed down to the next class in the returning sequence. The didFinishLoading method is overwritten to activate the DRM agent module 20 for closing the access to the electronic file, when finishing the loading of the DRM-protected content in this class.

In a fifth embodiment, the installation of the DRM agent module 20 in the WebKit engine 12 may be implemented in the committedLoad method and finishLoading method of the FrameLoaderClientAndroid class. The committedLoad method is overwritten to activate the DRM agent module 20 for obtaining the MIME type and data size of the electronic file, and replace the MIME type and data size contained in a ResourceResponse object with the obtained MIME type and data size of the electronic file. Also, the overwritten committedLoad method is used to activate the DRM agent module 20 for decrypting and un-packaging the DRM-protected content to obtain the electronic file, and determine the length and location of the electronic file in the memory. The ResourceResponse object, and the content and location of the electronic file are passed down to the next class in the returning sequence. The finishLoading method is overwritten to activate the DRM agent module 20 for closing the access to the electronic file, when finishing the loading of the DRM-protected content in this class.

In a sixth embodiment, the installation of the DRM agent module 20 in the WebKit engine 12 may be implemented in the didReceiveResponse method, didReceiveData method, and didFinishLoading method of the PluginView class or PluginStream class. The didReceiveResponse method is overwritten to activate the DRM agent module 20 for obtaining the MIME type and data size of the electronic file, and replace the MIME type and data size contained in a ResourceResponse object with the obtained MIME type and data size of the electronic file. The didReceiveData method is overwritten to activate the DRM agent module 20 for decrypting and un-packaging the DRM-protected content to obtain the electronic file, and determine the length and location of the electronic file in the memory. The ResourceResponse object, and the content and location of the electronic file are passed down to the next class in the returning sequence. The didFinishLoading method is overwritten to activate the DRM agent module 20 for closing the access to the electronic file, when finishing the loading of the DRM-protected content in this class.

Note that, in addition to the methods and classes mentioned in the six embodiments described above, other methods and classes in the WebKit engine 12 bearing similar functions (e.g., delivering information during the loading of the DRM-protected contents) or structures of the aforementioned ones, or the methods and classes with different name but similar functions or structures of the aforementioned ones, or the updated versions of the aforementioned methods and classes, or methods and classes being re-casted in different unit but still performing similar functions, may be selected for installing the DRM agent module 20, and the invention is not limited thereto. Alternatively, the installation of the DRM agent module 20 in the WebKit engine 12 is not limited to only the methods from the same class. That is, the DRM agent module 20 may be installed to any combination of the methods mentioned in the six embodiments, as long as the combination of methods covers the obtaining of necessary information, such as the MIME type, data length, and decrypted content, for processing of the DRM-protected content. For example, the installation of the DRM agent module 20 in the WebKit engine 12 may be implemented in the didReceiveResponse method of the WebUrlLoaderClient class, the didReceiveData method of the ResourceLoader class, and the didFinishLoading method of the PluginView or PluginStream class.

It is to be understood that, although the open-sourced web browser, such the Android native web browser or the Chromium web browser, are used as preferred exemplary web browser in the description of the aforementioned embodiments, another web browser for the Android system may be used instead, such as Firefox or Safari web browser for the Android system, or any web browser for the Android system, which is constructed by a WebView SDK and/or a WebKit engine bearing similar functions of the aforementioned ones, etc., or any web browser for the operating systems other than the Android system, e.g., the Mac OS X or iOS system, Windows XP/7/8 system, or others, which provide the WebView SDK with different architecture or do not provide the WebView SDK at all, and the invention is not limited thereto.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. An electronic device for digital content protection using Digital Rights Management (DRM), comprising:
a DRM agent, processing DRM-protected content associated with an electronic file or a web page;
a plug-in, enabling access of the electronic file; and
a web browser, comprising a WebView Software Development Kit (SDK) installed with the DRM agent or a WebKit engine installed with the DRM agent,
wherein the WebView SDK activates the processing of the DRM-protected content of the DRM agent to obtain the web page portion-by-portion, and displays the web page with the obtained portions, and
wherein the WebKit engine activates the processing of the DRM-protected content of the DRM agent to obtain the electronic file or the web page portion-by-portion, and uses the plug-in to access the electronic file with the obtained portions, or displays the web page with the obtained portions.

2. The electronic device of claim 1, wherein, prior to activating the processing of the DRM-protected content of the DRM agent, the WebView SDK or the WebKit engine determines whether the DRM-protected content is DRM protected using one of a plurality of DRM schemes according to a file extension of the DRM-protected content, and the processing of the DRM-protected content is activated in response to determining that the DRM-protected content is DRM protected using one of the DRM schemes.

3. The electronic device of claim 1, wherein the processing of the DRM-protected content of the DRM agent is activated also to determine whether the DRM-protected content is DRM protected using one of a plurality of DRM schemes according to a header of the DRM-protected content, and the obtaining of the electronic file or the web page portion-by-portion is performed in response to determining that the DRM-protected content is DRM protected using one of the DRM schemes.

4. The electronic device of claim 1, wherein the WebView SDK provides a set of Application Programming Interfaces (APIs), and the DRM agent is installed to a shouldInterceptRequest method of a child class which is registered to a WebViewClient class of the APIs, when the electronic device is operating an Android system, so that the processing of the DRM-protected content is activated when the web browser is required to access the DRM-protected content associated with the web page.

5. The electronic device of claim 1, wherein the DRM agent is installed to one or more of a plurality of methods in the WebKit engine, which are invoked during loading of the DRM-protected content associated with the electronic file, so that the processing of the DRM-protected content is activated when the web browser is required to access the DRM-protected content associated with the electronic file.

6. The electronic device of claim 5, wherein, when the electronic device is operating an Android system, the methods comprise:
a Start method, a GetMimeType method, a ReadRawData method, and a Kill method of a URLRequestFileJob or URLRequestHttpJob class;
an OnResponseStarted method and a OnReadCompleted method of a WebRequest class;
a didReceiveResponse method, a didReceiveData method, and a didFinishLoading method of a WebUrlLoaderClient, ResourceLoader, MainResourceLoader, SubresourceLoader, PluginView, or PluginStream class; and
a committedLoad method and a finishLoading method of a FrameLoaderClientAndroid class.

7. A method for digital content protection using Digital Rights Management (DRM) in an electronic device, comprising:
launching a web browser comprising a WebView Software Development Kit (SDK) installed with a DRM agent or a WebKit engine installed with the DRM agent, wherein the DRM agent is configured for processing DRM-protected content associated with an electronic file or a web page;
activating, by the WebView SDK, the DRM agent to process the DRM-protected content for obtaining the web page portion-by-portion, and displaying, by the WebView SDK, the web page with the obtained portions, in response to the web browser comprising the WebView SDK installed with the DRM agent; and
activating, by the WebKit engine, the DRM agent to process the DRM-protected content for obtaining the electronic file or the web page portion-by-portion, and using, by the WebKit engine, a plug-in to execute the electronic file with the obtained portions, or displaying, by the WebKit engine, the web page with the obtained portions, in response to the web browser comprising the WebKit engine installed with the DRM agent.

8. The method of claim 7, further comprising, prior to activating the processing of the DRM-protected content of the DRM agent, determining, by the WebView SDK or the WebKit engine, whether the DRM-protected content is DRM protected using one of a plurality of DRM schemes according to a file extension of the DRM-protected content, wherein the processing of the DRM-protected content is activated in response to determining that the DRM-protected content is DRM protected using one of the DRM schemes.

9. The method of claim 7, wherein the DRM agent is activated also to plurality of DRM schemes according to a header of the DRM-protected content, and the obtaining of the electronic file or the web page portion-by-portion is performed in response to determining that the DRM-protected content is DRM protected using one of the DRM schemes.

10. The method of claim 7, wherein the WebView SDK provides a set of Application Programming Interfaces (APIs), and the DRM agent is installed to a shouldInterceptRequest method of a child class which is registered to a WebViewClient class of the APIs, when the electronic device is operating an Android system, so that the processing of the DRM-protected content is activated when the web browser is required to access the DRM-protected content associated with the web page.

11. The method of claim 7, wherein the DRM agent is installed to one or more of a plurality of methods in the WebKit engine, which are invoked during loading of the DRM-protected content associated with the electronic file, so that the processing of the DRM-protected content is activated when the web browser is required to access the DRM-protected content associated with the electronic file.

12. The method of claim 11, wherein, when the electronic device is operating an Android system, the methods comprise:
a Start method, a GetMimeType method, a ReadRawData method, and a Kill method of a URLRequestFileJob or URLRequestHttpJob class;
an OnResponseStarted method and a OnReadCompleted method of a WebRequest class;
a didReceiveResponse method, a didReceiveData method, and a didFinishLoading method of a WebUrlLoaderClient, ResourceLoader, MainResourceLoader, SubresourceLoader, PluginView, or PluginStream class; and
a committedLoad method and a finishLoading method of a FrameLoaderClientAndroid class.

13. An electronic device for digital content protection using Digital Rights Management (DRM), comprising:
a plurality of DRM agents, supporting a plurality of DRM schemes for processing DRM-protected content associated with an electronic file or a web page using one of the DRM schemes;
a plug-in, enabling access of the electronic file; and
a web browser, comprising a WebView Software Development Kit (SDK) installed with the DRM agents or a WebKit engine installed with the DRM agents,
wherein the WebView SDK activates the processing of the DRM-protected content of the DRM agents to obtain the web page portion-by-portion, and displays the web page with the obtained portions, and
wherein the WebKit engine activates the processing of the DRM-protected content of the DRM agents to obtain the electronic file or the web page portion-by-portion, and uses the plug-in to execute the electronic file with the obtained portions, or displays the web page with the obtained portions.

14. The electronic device of claim 13, wherein, prior to activating the processing of the DRM-protected content of the DRM agents, the WebView SDK or the WebKit engine determines whether the DRM-protected content is DRM protected using one of the DRM schemes according to a file extension of the DRM-protected content, and the processing of the DRM-protected content is activated in response to determining that the DRM-protected content is DRM protected using one of the DRM schemes.

15. The electronic device of claim 13, wherein the processing of the DRM-protected content of the DRM agents is activated also to determine whether the DRM-protected content is DRM protected using one of the DRM schemes according to a web page portion-by-portion is performed in response to determining that the DRM-protected content is DRM protected using one of the DRM schemes.

16. The electronic device of claim 13, wherein the WebView SDK provides a set of Application Programming Interfaces (APIs), and the DRM agents are installed to a shouldInterceptRequest method of a child class which is registered to a WebViewClient class of the APIs, when the electronic device is operating an Android system, so that the processing of the DRM-protected content is activated when the web browser is required to access the DRM-protected content associated with the web page.

17. The electronic device of claim 13, wherein the DRM agents are installed to one or more of a plurality of methods in the WebKit engine, which are invoked during loading of the DRM-protected content associated with the electronic file, so that the processing of the DRM-protected content is activated when the web browser is required to access the DRM-protected content associated with the electronic file.

18. The electronic device of claim 17, wherein, when the electronic device is operating an Android system, the methods comprise:
a Start method, a GetMimeType method, a ReadRawData method, and a Kill method of a URLRequestFileJob or URLRequestHttpJob class;
an OnResponseStarted method and a OnReadCompleted method of a WebRequest class;
a didReceiveResponse method, a didReceiveData method, and a didFinishLoading method of a WebUrlLoaderClient, ResourceLoader, MainResourceLoader, SubresourceLoader, PluginView, or PluginStream class; and
a committedLoad method and a finishLoading method of a FrameLoaderClientAndroid class.
